(19) United States
(12) Patent Application Publication
(10) Pub. No.: US 2014/0360288 A1
(43) Pub. Date: Dec. 11, 2014

(54) DROPLET FORMING DEVICE AND METHOD OF FORMING DROPLET USING THE SAME

(71) Applicant: SAMSUNG ELECTRO-MECHANICS CO., LTD., Suwon (KR)

(72) Inventors: Sang Hyun YI, Suwon (KR); Dong Woo LEE, Suwon (KR); Bo Sung KU, Suwon (KR)

(73) Assignee: SAMSUNG ELECTRO-MECHANICS CO., LTD., Suwon (KR)

(21) Appl. No.: 14/015,520

(22) Filed: Aug. 30, 2013

(30) Foreign Application Priority Data
Jun. 11, 2013 (KR) 10-2013-0066254

(51) Int. Cl. B01L 3/00

(52) U.S. Cl. CPC B01L 3/502792
USPC 73/864; 422/503

(57) ABSTRACT

There is provided a droplet forming device including: a guide part having a pillar shape in which the center thereof is empty; a central separation plate formed above the guide part and having a discharging hole formed in the center thereof; and a fluid storing part formed above the central separation plate.

### CROSS-REFERENCE TO RELATED APPLICATIONS

This application claims the priority of Korean Patent Application No. 10-2013-0066254 filed on Jun. 11, 2013, in the Korean Intellectual Property Office, the disclosure of which is incorporated herein by reference.

### BACKGROUND OF THE INVENTION

1. Field of the Invention

The present invention relates to a droplet forming device capable of being easily and simply used, and a method of forming a droplet using the same.

2. Description of the Related Art

The demand for biomedical devices and a biotechnology for rapidly diagnosing various human diseases has recently increased.

Therefore, the development of a biosensor or a biochip capable of providing diagnostic results for a specific disease in a short time, the testing for which previously took an extended period of time when performed in a hospital or a research laboratory, has been actively conducted.

Research into biosensors and biochips has also been demanded for use in pharmaceutical companies, cosmetics companies, and the like, in addition to hospitals.

In the pharmaceutical industry, the cosmetics industry, and the like, a method of verifying the effectiveness and stability (toxicity) of a specific drug by determining a reaction of a cell to the specific drug has been used. However, in the method according to the related art, since animals or a large amount of reagent should be used, large amounts of time and relatively high costs have been required.

Therefore, the development of a biosensor or a biochip capable of rapidly and accurately diagnosing diseases while simultaneously decreasing costs has been demanded.

The biochip may be divided into a deoxyribonucleic acid (DNA) chip, a protein chip, and a cell chip, according to types of biomaterial fixed to a substrate.

In the early stage of biochip development, in accordance with research into human genetic information, DNA chips have been prominent. However, as interest in proteins maintaining vital activity and cells, protein conjugates fundamental to living things, has increased, interest in protein chips and cell chips has also increased.

Protein chips initially had difficulties such as non-selective adsorption. However, several remarkable results from protein chips have recently been achieved.

Cell chips, effective mediums having a wide range of applications, such as in the development of new medicines as well as in the areas of genomics and proteomics, and other areas, have been prominent.

When performing research using a biochip, a very important element in determining the accuracy of an experimental result is to supply a quantified amount of a liquid such as a culture medium or a reagent.

Here, the supply a quantified amount of a liquid such as a culture medium or a reagent is more important in a cell chip used for a toxicity test, an anti-cancer agent sensitivity test, and a resistance test for developing a new medicine to supply the quantified liquid.

According to the related art, when supplying a liquid to the biochip, a liquid discharging device including a ceramic nozzle connected to a pump unit by a tube has been used. Even though the liquid discharging device adjusts a liquid discharge amount by an electronic control, a minimal amount of a single droplet supplied through the ceramic nozzle is on the level of several tens of micro-liters (μ/s), it may be difficult to supply a quantified amount of liquid and supply a fine amount of liquid with the use of a ceramic nozzle.

In order to solve these problems, an electronic pipette capable of supplying a droplet in the range of several nls under electronic control has been developed. However, such an electronic pipette may have a difficulty in supplying a large amount of droplets and discharging a highly-viscous material.

Therefore, in the related art, a device for discharging a large amount of liquid and a device for discharging a small amount of liquid depending on an amount of liquid to be discharged should be provided, or a device for discharging a low-viscosity liquid and a device for discharging a high-viscosity liquid, depending on viscosity of a liquid, should be provided, inconvenient in view of use and expensive in view of a cost thereof.

In addition, since the device for discharging a liquid and the electronic pipette should be alternately used depending on the amount of liquid to be discharged and the viscosity of the liquid, an amount of time required to replace or operate an experimental device has increased and accuracy of an experiment has decreased due to a decrease in user concentration.

Therefore, a device and a method capable of simply forming a large amount of droplets have been demanded.

The following Related Art Document (Patent Document 1) discloses a space separation type of nano array biochip.

Patent Document 1 has described a plurality of protrusion parts of which only the top is provided with a spot; however, the spot is formed by overturning a nano array structure to allow the nano array structure to contact an aqueous solution, thereby fixing protein, DNA, ribonucleic acid (RNA), or an epithelial cell to the top of the protrusion part, different to the present invention.

### RELATED ART DOCUMENT

(Patent Document 1) Korean Patent Laid-Open Publication No. 2011-0024623

### SUMMARY OF THE INVENTION

An aspect of the present invention provides a droplet forming device capable of simultaneously forming a plurality of droplets, of being simply used, and decreasing a time required to form the droplets, and a method of forming droplets using the same.

According to an aspect of the present invention, there is provided a droplet forming device including: a guide part having a pillar shape in which the center thereof is empty; a central separation plate formed above the guide part and having a discharging hole formed in the center thereof; and a fluid storing part formed above the central separation plate.

An end portion of a lower portion of the guide part may have a tapered shape or a stepped shape.

The discharging hole may have a shape in which a diameter thereof is reduced toward a lower portion thereof.

The discharging hole may have a diameter of 0.9 to 3 mm.

The droplet forming device may further include a pressure applying part applying pressure to the fluid storing part.

According to another aspect of the present invention, there is provided a droplet forming device including: a droplet forming device including a guide part having a pillar shape in which the center thereof is empty, a central separation plate formed above the guide part and having a discharging hole formed in the center thereof, and a fluid storing part formed above the central separation plate; a substrate; and a plurality of pillar members formed on the substrate and having droplets formed thereon.

The centers of the discharging hole and the pillar member may coincide with each other.

The pillar member may include a fixing layer formed thereon in order to improve adhesion of the droplet.

The droplet forming device may further include a position adjusting part formed in a position at which a lower portion of the pillar member and the substrate meet each other.

The position adjusting part may have a tapered shape or a stepped shape.

According to another aspect of the present invention, there is provided a method of forming a droplet, including: preparing a fluid for forming the droplet; preparing a droplet forming device including a guide part having a pillar shape in which the center thereof is empty, a central separation plate formed above the guide part and having a discharging hole formed in the center thereof, and a fluid storing part formed above the central separation plate; preparing a substrate and a plurality of pillar members formed on the substrate and having the droplet formed thereon; injecting the fluid into the fluid storing part to thereby form the fluid in a droplet shape at the discharging hole; contacting the fluid in the droplet shape formed at the discharging hole and an upper portion of the pillar member with each other; and spacing the discharging hole and the pillar member apart from each other.

An end portion of a lower portion of the guide part may have a tapered shape or a stepped shape.

A position adjusting part may be further formed in a position at which a lower portion of the pillar member and the substrate meet each other, wherein the position adjusting part has a tapered shape or a stepped shape.

The contacting of the fluid in the droplet shape formed at the discharging hole and the upper portion of the pillar member with each other may be performed by engaging the end portion of the lower portion of the guide part and the position adjusting part with each other.

The contacting of the fluid in the droplet shape formed at the discharging hole and the upper portion of the pillar member with each other may be performed by vertically lowering the droplet forming device, and the spacing of the discharging hole and the pillar member apart from each other may be performed by vertically raising the droplet forming device.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a droplet forming device according to an embodiment of the present invention;

FIG. 2 is a schematic cross-sectional view of the droplet forming device of FIG. 1;

FIGS. 3A and 3B are enlarged views of the part E of FIG. 2;

FIGS. 4A and 4B are enlarged views of the part H of FIG. 2;

FIG. 5 is a schematic perspective view of a pillar member of a droplet forming device according to the embodiment of the present invention;

FIG. 6 is a schematic cross-sectional view of the pillar member shown in FIG. 5;

FIG. 7 is a schematic cross-sectional view of the pillar member of which a position adjusting part has a stepped shape;

FIG. 8 is a schematic cross-sectional view of the pillar member of which the position adjusting part has a tapered shape;

FIG. 9 is a schematic perspective view of the droplet forming device according to the embodiment of the present invention; and

FIGS. 10 through 12 are schematic cross-sectional views sequentially showing a method of operating the droplet forming device according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

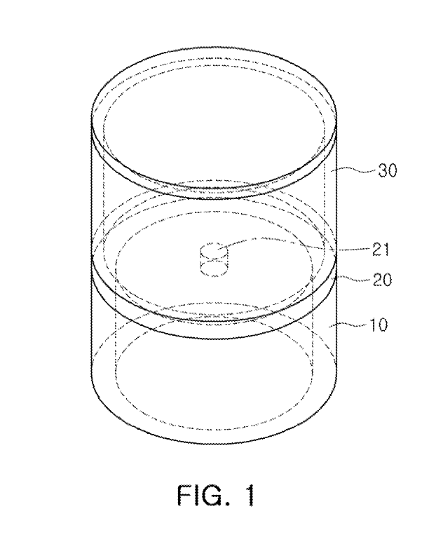

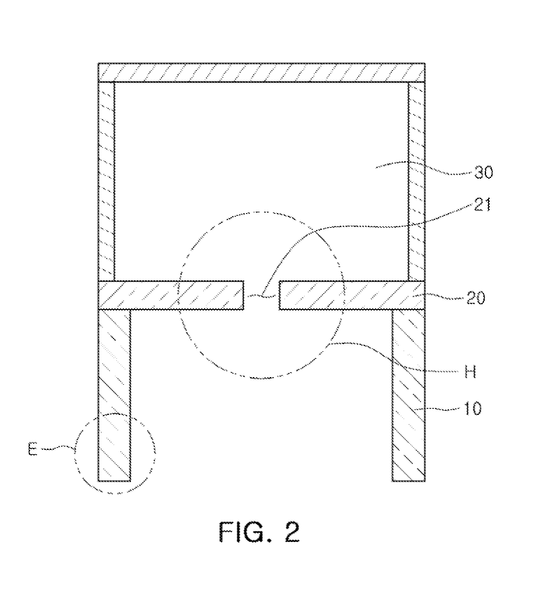

FIG. 1 is a perspective view of a droplet forming device according to an embodiment of the present invention; and FIG. 2 is a schematic cross-sectional view of the droplet forming device of FIG. 1.

Hereinafter, a structure of the droplet forming device according to the embodiment of the present invention will be described with reference to FIGS. 1 and 2.

Referring to FIGS. 1 and 2, the droplet forming device according to the embodiment of the present invention may include a guide part 10 having a pillar shape in which the center thereof is empty; a central separation plate 20 formed above the guide part 10 and having a discharging hole 21 formed in the center thereof; and a fluid storing part 30 formed above the central separation plate 20.

The guide part 10 may have the pillar shape. More specifically, the guide part 10 may have a circular pillar shape, a rectangular pillar shape, or a triangular pillar shape, but is not limited thereto.

The guide part 10 may be coupled to a position adjusting part 41 of a pillar member to be described below to serve to allow the centers of the discharging hole 21 and the pillar member to coincide with each other.

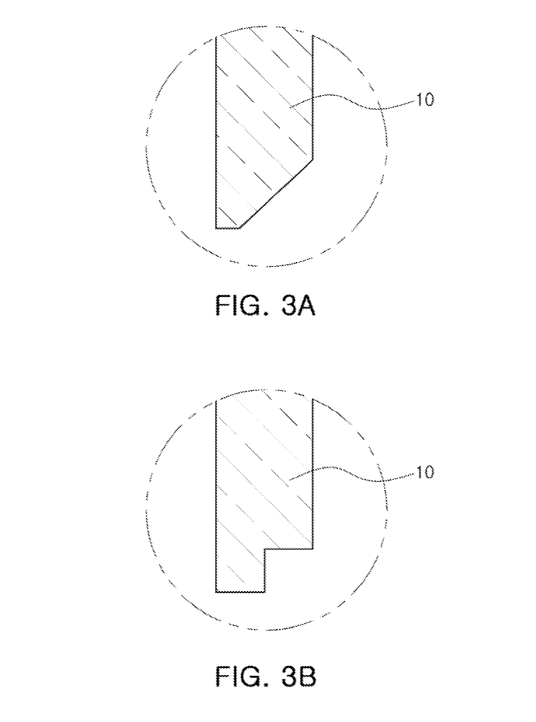

More specifically, referring to FIGS. 3A and 3B, enlarged views of the part E shown in FIG. 2, an end portion of a lower portion of the guide part 10 may have a tapered shape or a stepped shape.

That is, the shape of the end portion of the lower portion of the guide part 10 is changed, whereby a coupling feature between the droplet forming device and the position adjusting part may be improved.

Particularly, in the case in which the end portion of the lower portion of the guide part 10 may have the tapered shape, the guide part 10 may be smoothly coupled to the position adjusting part to prevent impacts from being applied to the droplet forming device.

In addition, the guide part 10 may serve to prevent a fluid stored in the fluid storing part 30 from being discharged to an undesired position when the fluid is discharged through the discharging hole 21.

Further, a length of the guide part 10 may be adjusted to allow a desired droplet to be formed in the pillar member.

The fluid storing part 30 may include a cell, a culture medium, a specific drug, or the like, stored therein in order to form a desired droplet.

The fluid storing part 30 may further include a pressure applying part (not shown) in order to allow pressure of the fluid storing part 30 to be constantly maintained or adjusted.

The pressure applying part may be formed of a vacuum pump or a piezoelectric material.

The central separation plate 20 may have the discharging hole 21 formed in the central portion thereof.

The discharging hole 21 may have a diameter small enough to allow the fluid stored in the fluid storing part 20 not to naturally flow out therefrom.

That is, the discharging hole 21 may have a diameter of 0.9 to 3 mm.

In the case in which the discharging hole 21 has a diameter of less than 0.9 mm, the fluid stored in the fluid storing part 30 may not flow out through the discharging hole 21, such that a droplet may not be formed below the central separation plate 20.

In the case in which the discharging hole 21 has a diameter exceeding 3 mm, the fluid stored in the fluid storing part 30 may excessively flow through the discharging hole 21, such that the droplet may not be formed below the central separation plate 20.

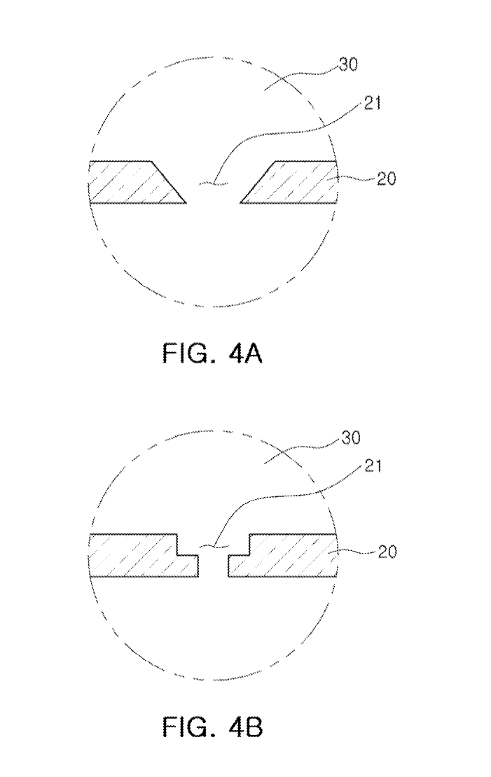

More specifically, referring to FIGS. 4A and 4B, enlarged views of the part H shown in FIG. 2, the discharging hole 21 may have a tapered shape or a stepped shape in which a diameter of a lower portion thereof is smaller than that of an upper portion thereof.

The discharging hole 21 may have a shape in which the diameter of the lower portion thereof is smaller than that of the upper portion thereof to prevent the fluid from flowing down and allow a shape of the fluid to be maintained as a hemispherical droplet under the discharging hole 21.

When the discharging hole 21 may have a shape in which the diameter of the lower portion thereof is larger than that of the upper portion thereof, the droplet may not formed to have a desired shape below the central separation plate 20.

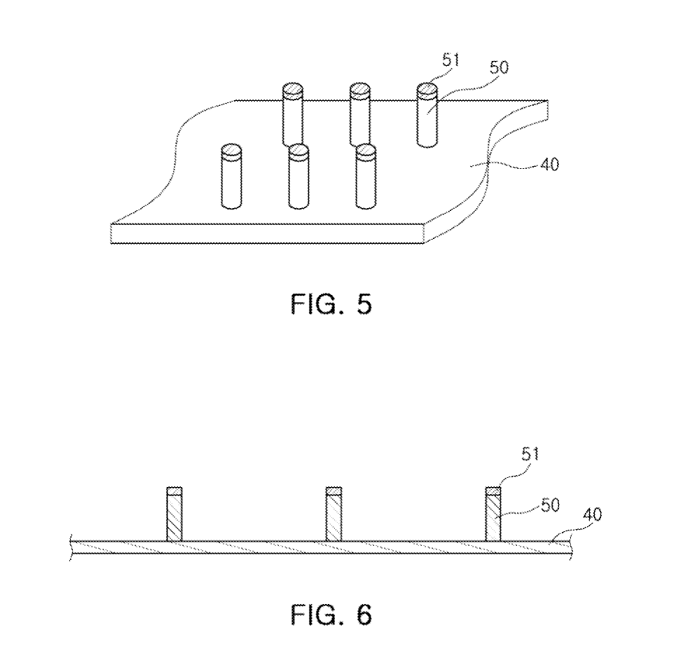

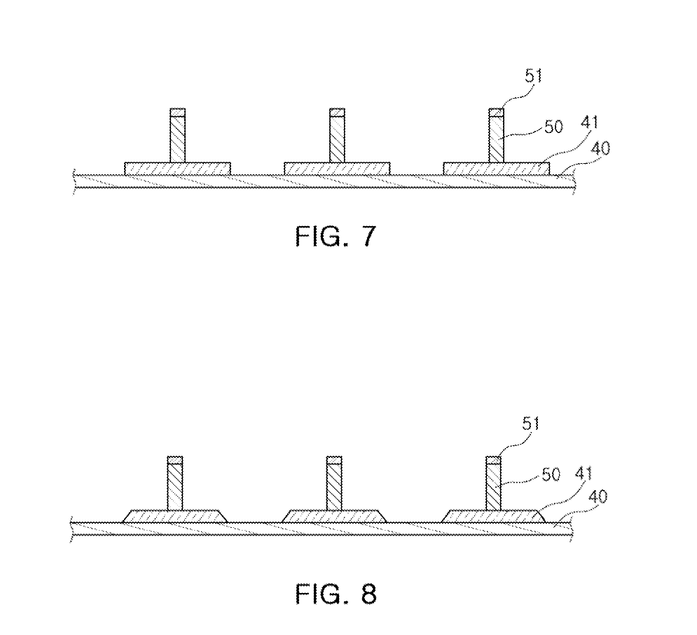

FIG. 5 is a schematic perspective view of a pillar member 50 of a droplet forming device according to the embodiment of the present invention; and FIG. 6 is a schematic cross-sectional view of the pillar member 50 shown in FIG. 5.

The pillar member 50 means a structure protruding at a predetermined height from one surface of a substrate 40 and may be understood to be a fine rod or a fine pin.

The pillar member 50 may be a three-dimensional structure and have a biomaterial attached to a protrusion surface thereof.

For example, the pillar member 50 may have various heights, for example, 50 to 500 μm, but is not limited thereto.

In addition, shapes of a cross section and a protrusion surface of the pillar member 50 are not specifically limited.

The pillar member 50 may be formed in a matrix form in the substrate 40.

A kind of the biomaterial is not specifically limited but may be, for example, a nucleic acid arrangement such as a deoxyribonucleic acid (DNA), a ribonucleic acid (RNA), or the like, a peptide, a protein, a fatty acid, an organic or inorganic chemical molecule, a virus particles, a prokaryotic cell, an organelle, or the like.

In addition, a kind of cell is not specifically limited, and may be, for example, a microorganism, a plant or animal cell, a tumor cell, a neural cell, an endovascular cell, an immune cell, or the like.

According to the embodiment of the present invention, the biomaterials may be attached to the protrusion surface of the pillar member 50 in a state in which they are dispersed in dispersion materials capable of maintaining organization and functions thereof.

That is, the dispersion materials including the biomaterials may be stored in the fluid storing part 30 of the droplet forming device described above, and the biomaterials may be attached to the protrusion surface of the pillar member 50 using the droplet forming device.

The dispersion material may be a porous material through which a reagent such as a culture medium, a specific drug, various aqueous solutions, or the like, may penetrate. An example of the dispersion material may include sol-gel, hydro gel, alginate gel, organogel or xerogel, gelatin, collagen, or the like, but is not limited thereto.

According to the embodiment of the present invention, the biomaterials may be attached in a three-dimensional structure to the protrusion surface of the pillar member 50 in a state in which they are dispersed in the dispersion materials. Since the biomaterials having the three-dimensional structure are more similar to a bio-environment, more accurate test results may be obtained.

According to the embodiment of the present invention, the pillar member 50 may have a fixing layer 51 formed on the protrusion surface in order to fix the biomaterials thereto.

The fixing layer 51 may be formed of, for example, polyethylene imine, polylysine, polyvinyl amine, polyaryl amine, fibronectin, gelatin, collagen, elastin, laminin, or the like, or a mixture thereof, but is not limited thereto.

The fixing layer 51 may contain a gelating material capable of gelating the dispersion materials. The gelating material may be, for example, BaCl₂, palladium acetate, N,N′-Bis(salicylidene)pentamethylenediamine, potassium phosphate, or the like, or at least one mixture thereof, but is not limited thereto.

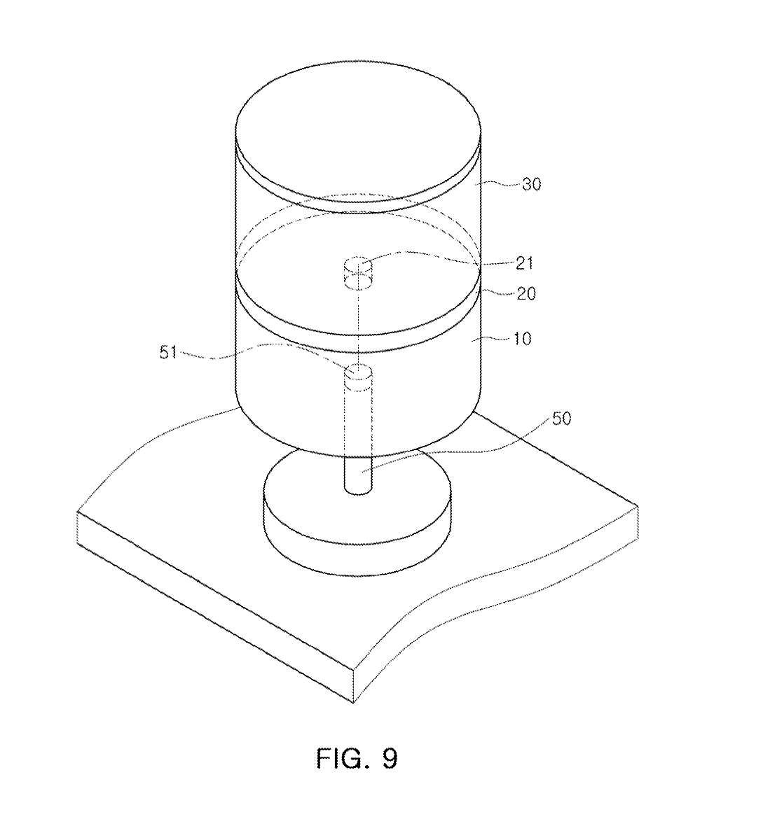

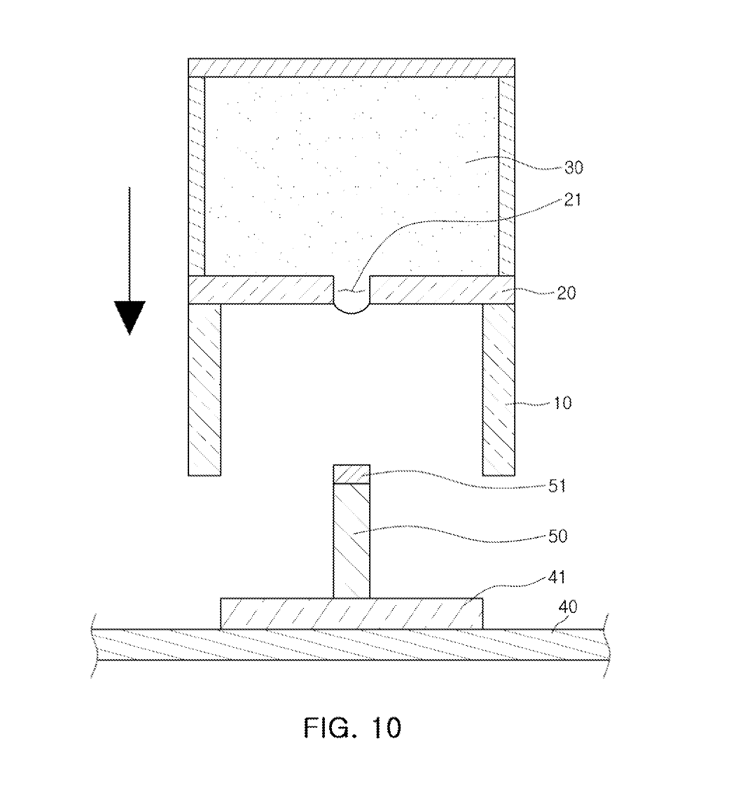

FIG. 7 is a schematic cross-sectional view of the pillar member 50 of which a position adjusting part 41 has a stepped shape; and FIG. 8 is a schematic cross-sectional view of the pillar member 50 of which the position adjusting part 51 has a tapered shape.

The position adjusting part 41 may be formed in a position at which the pillar member 50 and the substrate 40 contact each other, but is not limited thereto.

The position adjusting part 41 may be coupled to the end portion of the lower portion of the guide part 10 of the droplet forming device described above to allow the centers of the discharging hole 21 of the droplet forming device and the pillar member 50 to coincide with each other.

The position adjusting part 41 may be formed in the stepped shape or the tapered shape in order to improve a coupling feature between the position adjusting part 41 and the end portion of the lower portion of the guide part 10 of the droplet forming device.

Referring to FIG. 7, the position adjusting part 41 may be formed to have the stepped shape.

In the case in which the position adjusting part 41 has the stepped shape, the end portion of the lower portion of the guide part 10 of the droplet forming device and the position adjusting part 41 may be precisely coupled to each other.

Referring to FIG. 8, the position adjusting part 41 may be formed in the tapered shape.

In the case in which the position adjusting part 41 has the tapered shape, impacts due to coupling that may be generated when the droplet forming device and the pillar member 50 are coupled to each other is decreased, whereby sizes of droplets to be formed may be maintained to be constant.

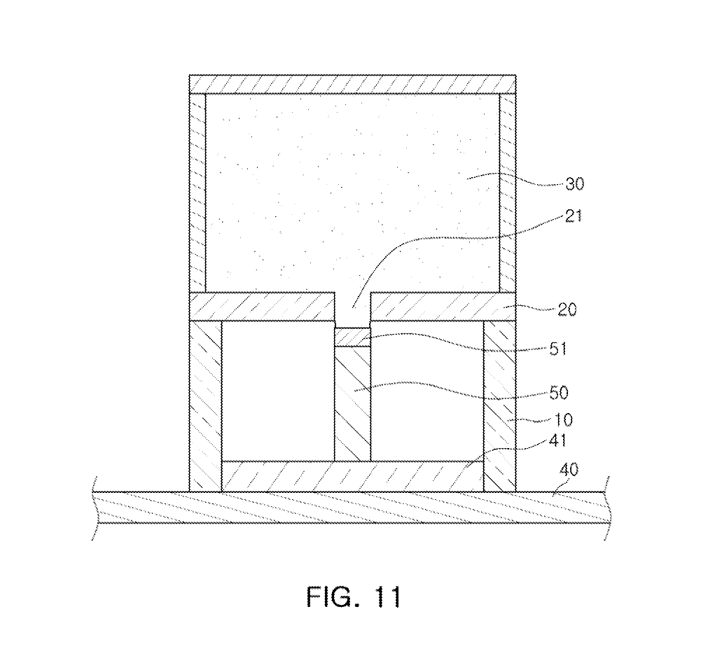

FIG. 9 is a schematic perspective view of the droplet forming device according to the embodiment of the present invention.

Referring to FIG. 9, the droplet forming device according to the embodiment of the present invention may include the droplet forming device including the guide part 10 having the pillar shape in which the center thereof is empty, the central separation plate 20 formed above the guide part 10 and having the discharging hole 21 formed at the center thereof, and the fluid storing part 30 formed above the central separation plate 20; the substrate 40; and a plurality of pillar members 50 formed on the substrate 40 and having the droplets formed thereon.

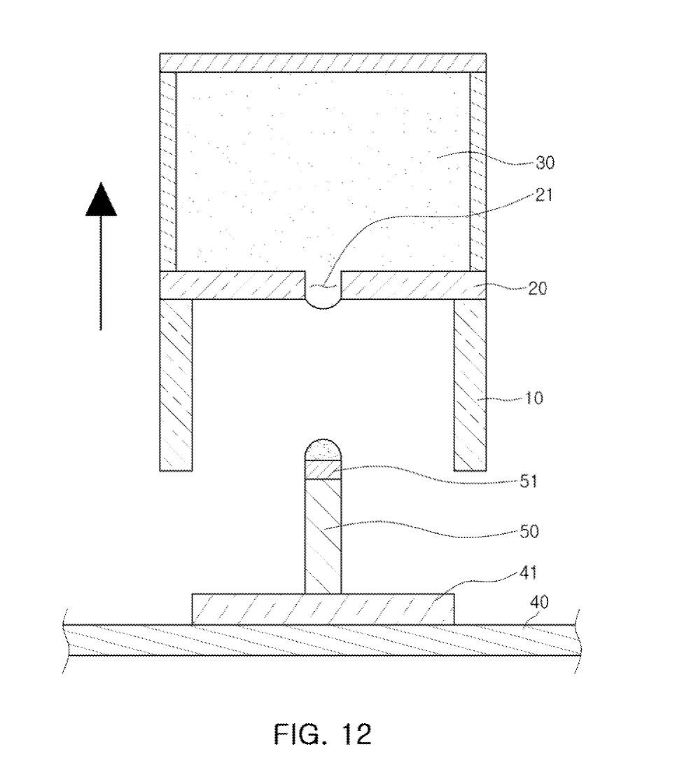

FIGS. 10 through 12 are schematic cross-sectional views sequentially showing a method of operating the droplet forming device according to the embodiment of the present invention.

A method of forming a droplet using the droplet forming device according to the embodiment of the present invention will be described with reference to FIGS. 10 to 12.

Referring to FIG. 10, a fluid for forming the droplet is prepared in the fluid storing part 30 of the droplet forming device.

The fluid may include the biomaterials.

A kind of the biomaterial is not specifically limited but may be, for example, a nucleic acid arrangement such as a deoxyribonucleic acid (DNA), a ribonucleic acid (RNA), or the like, pa eptide, a protein, a fatty acid, an organic or inorganic chemical molecule, a virus particle, a prokaryotic cell, an organelle, or the like.

In addition, a kind of cell is not specifically limited, and may be, for example, a microorganism, a plant or animal cell, a tumor cell, a neural cell, an endovascular cell, an immune cell, or the like.

According to the embodiment of the present invention, the biomaterials may be dispersed in dispersion materials capable of maintaining organization and functions thereof.

That is, the dispersion materials including the biomaterials may be stored in the fluid storing part 30 of the droplet forming device described above, and the biomaterials may be attached to the protrusion surface of the pillar member 50 using the droplet forming device.

The dispersion material may be a porous material through which a reagent such as a culture medium, a specific drug, various aqueous solutions, or the like, may penetrate. An example of the dispersion material may include sol-gel, hydro gel, alginate gel, organogel or xerogel, gelatin, collagen, or the like, but is not limited thereto.

Next, the droplet forming device including the guide part 10 having the pillar shape in which the center thereof is empty, the central separation plate 20 formed above the guide part 10 and having the discharging hole 21 formed at the center thereof, and the fluid storing part 30 formed above the central separation plate 20 is prepared.

Then, the substrate 40 on which the droplet is to be formed and the plurality of pillar members 50 formed on the substrate 40 and having the droplet formed thereon are prepared.

The fluid that has been first prepared and includes the biomaterials may be injected into the fluid storing part to thereby be formed in a droplet shape at the discharging hole 21.

The droplet may be formed to have a hemispherical shape below the discharging hole 21 of the central separation plate 20.

That is, since the discharging hole 21 has the diameter of 0.9 to 3 mm, a hemispherical droplet having an appropriate size may be formed without flowing from the discharging hole 21.

In order to form the droplet on the protrusion surface of the pillar member 50, the end portion of the lower portion of the guide part 10 of the droplet forming device may be coupled to the position adjusting part 41 of the pillar member 50, as shown in an arrow of FIG. 10.

The end portion of the lower portion of the guide part 10 is coupled to the pillar member 50, whereby the fluid formed at the discharging hole 21 and having the droplet shape and the pillar member 50 may contact each other.

Referring to FIG. 11, in the case in which the end portion of the lower portion of the guide part 10 and the pillar member 50 are coupled to each other, the fluid formed at the discharging hole 21 in FIG. 10 and having the droplet shape may contact an upper portion of the pillar member 50, such that it partially moves to the pillar member 50.

Referring to FIG. 12, after the fluid formed at the discharging hole 21 and having the droplet shape contacts the pillar member 50, the droplet forming device is moved as shown in an arrow of FIG. 12 to space the discharging hole 21 and the pillar member 50 apart from each other, whereby the droplet having an appropriate size may be formed on the pillar member 50.

That is, the droplet forming device in which the fluid is stored is vertically lowered to contact the fluid formed at the discharging hole 21 and having the droplet shape and the upper portion of the pillar member 50 with each other and the droplet forming device is vertically raised to space the discharging hole 21 and the pillar member 50 apart from each other, whereby the droplet having an appropriate size may be formed on the pillar member 50.

The droplet forming devices according to the embodiment of the present invention are not limited to being singly formed, but may be formed on different substrates so as to correspond to the pillar members 50.

That is, the method of forming a droplet is repeated once using the plurality of pillar members 50 and a plurality of droplet forming devices corresponding to the plurality of pillar members 50, whereby a plurality of droplets may be formed.

As set forth above, with the droplet forming device according to the embodiment of the present invention, the discharging hole is directly positioned below the fluid storing part and gravity or the pressure applying part is used, whereby the fluid in the droplet shape may be simply formed at the discharging hole.

In addition, with the droplet forming device according to the embodiment of the present invention, the gravity or the pressure applying part is used to form the fluid in the droplet shape at the discharging hole and contact the fluid and an upper portion of the pillar member with each other, whereby the droplet may be formed. Therefore, the droplet forming device may be simply used and decrease a time required to form the droplet.

More specifically, with the method of forming a droplet using the droplet forming device according to the embodiment of the present invention, the droplet forming device is vertically moved to contact the fluid in the droplet shape formed at the discharging hole and the upper portion of the pillar member with each other, whereby the droplet may be simply formed.

For example, as the fluid storing part, a fluid storing part having a form in which an upper portion is opened may be used.

While the present invention has been shown and described in connection with the embodiments, it will be apparent to those skilled in the art that modifications and variations can be made without departing from the spirit and scope of the invention as defined by the appended claims.

What is claimed is:

1. A droplet forming device comprising:
a guide part having a pillar shape in which the center thereof is empty;
a central separation plate formed above the guide part and having a discharging hole formed in the center thereof; and
a fluid storing part formed above the central separation plate.

2. The droplet forming device of claim 1, wherein an end portion of a lower portion of the guide part has a tapered shape or a stepped shape.

3. The droplet forming device of claim 1, wherein the discharging hole has a shape in which a diameter thereof is reduced toward a lower portion thereof.

4. The droplet forming device of claim 1, wherein the discharging hole has a diameter of 0.9 to 3 mm.

5. The droplet forming device of claim 1, further comprising a pressure applying part applying pressure to the fluid storing part.

6. A droplet forming device comprising:
a droplet forming device including a guide part having a pillar shape in which the center thereof is empty, a central separation plate formed above the guide part and having a discharging hole formed in the center thereof, and a fluid storing part formed above the central separation plate;
a substrate; and
a plurality of pillar members formed on the substrate and having droplets formed thereon.

7. The droplet forming device of claim 6, wherein the centers of the discharging hole and the pillar member coincide with each other.

8. The droplet forming device of claim 6, wherein the pillar member includes a fixing layer formed thereon in order to improve adhesion of the droplet.

9. The droplet forming device of claim 6, further comprising a position adjusting part formed in a position at which a lower portion of the pillar member and the substrate meet each other.

10. The droplet forming device of claim 9, wherein the position adjusting part has a tapered shape or a stepped shape.

11. A method of forming a droplet, comprising:
preparing a fluid for forming the droplet;
preparing a droplet forming device including a guide part having a pillar shape in which the center thereof is empty, a central separation plate formed above the guide part and having a discharging hole formed in the center thereof, and a fluid storing part formed above the central separation plate;
preparing a substrate and a plurality of pillar members formed on the substrate and having the droplet formed thereon;
injecting the fluid into the fluid storing part to thereby form the fluid in a droplet shape at the discharging hole;
contacting the fluid in the droplet shape formed at the discharging hole and an upper portion of the pillar member with each other; and
spacing the discharging hole and the pillar member apart from each other.

12. The method of claim 11, wherein an end portion of a lower portion of the guide part has a tapered shape or a stepped shape.

13. The method of claim 12, wherein a position adjusting part is further formed in a position at which a lower portion of the pillar member and the substrate meet each other, the position adjusting part having a tapered shape or a stepped shape.

14. The method of claim 13, wherein the contacting of the fluid in the droplet shape formed at the discharging hole and the upper portion of the pillar member with each other is performed by engaging the end portion of the lower portion of the guide part and the position adjusting part with each other.

15. The method of claim 11, wherein the contacting of the fluid in the droplet shape formed at the discharging hole and the upper portion of the pillar member with each other is performed by vertically lowering the droplet forming device, and
the spacing of the discharging hole and the pillar member apart from each other is performed by vertically raising the droplet forming device.
